(19) United States
(12) Patent Application Publication
(10) Pub. No.: US 2020/0238227 A1
(43) Pub. Date: Jul. 30, 2020

(54) POROUS MATERIALS FROM COMPLEX BLOCK COPOLYMER ARCHITECTURES

(71) Applicant: TeraPore Technologies, Inc., South San Francisco, CA (US)

(72) Inventors: Rachel Mika Dorin, San Francisco, CA (US); Spencer William Robbins, San Francisco, CA (US)

(73) Assignee: TeraPore Technologies, Inc., South San Francisco, CA (US)

(21) Appl. No.: 16/633,508

(22) PCT Filed: Jul. 23, 2018
(86) PCT No.: PCT/US2018/043303

§ 371 Date: Jan. 23, 2020

Related U.S. Application Data
(60) Provisional application No. 62/625,633, filed on Feb. 2, 2018.
(60) Provisional application No. 62/564,669, filed on Sep. 28, 2017.
(60) Provisional application No. 62/536,835, filed on Jul. 25, 2017.

(51) Int. Cl. B01D 71/80; C08L 53/02; C08F 297/00; C08J 5/18; C08J 9/00; C08J 9/28; B01D 69/02; B01D 71/26; B01D 71/28; B01D 71/40

(52) U.S. Cl. CPC B01D 71/80; B01D 2325/021; C08F 297/00; C08J 5/18; C08J 9/0061; C08J 9/283; B01D 69/02; B01D 71/26; B01D 71/28; B01D 71/40; C08L 2205/025; C08L 2203/14; C08J 2201/0544; C08J 2205/042; C08J 2205/044; C08J 2353/02; C08J 2453/02; C08L 53/02

(57) ABSTRACT

Self-assembled porous block copolymer materials with a complex block copolymer architecture, methods of preparing, uses for separation and detection, and devices for using as such. The porous materials contain at least one of macro, meso, or micro pores, at least some of which are isoporous, and include at least one block copolymer with at least two chemically distinct blocks, which further comprises a complex architecture such as: multiple distinct monomers in or between blocks, branching, crosslinking, or ring architectures.

### CROSS-REFERENCE TO RELATED PATENT APPLICATIONS

This application claims the benefit of priority to U.S. Provisional Patent Application Ser. No. 62/536,835, filed Jul. 25, 2017, U.S. Provisional Patent Application Ser. No. 62/564,669. filed Sep. 28, 2017 and U.S. Provisional Patent Application Ser. No. 62/625,633, filed Feb. 2, 2018, the entireties of which are incorporated herein by reference.

The invention relates to a porous material comprising a block copolymer with a complex block copolymer architecture, a method for making said materials, uses of the materials, and devices comprising the materials for uses.

### BACKGROUND OF THE INVENTION

The ability of block copolymers to self-assemble is one of their most attractive features. The self-assembly behavior of block copolymers derives from the incompatibility of different segments (blocks), causing demixing. Due to the covalent bonds between blocks and the nanoscale size of the block copolymer segments, the blocks can only nanophase separate rather than macroscopically/bulk demix. This nanophase separation coupled with the well-defined structure of the block copolymers can be utilized to generate well-defined nanoscale features. The self-assembly of block copolymers can be used to generate porous materials wherein the pores are on the order of about 1-200 nm. These porous materials are used for applications including gas and liquid separations, and lithography.

Various techniques are known in the art, for example see: U.S. Pat. No. 7,056,455 B2, U.S. Pat. Nos. 8,939,294, 6,592,764 B1, U.S. 2011/0130478 A1, U.S. 2013/0129972 A1, U.S. Pat. No. 8,206,601 B2, U.S. Pat. No. 9,441,078 B2, U.S. Pat. No. 9,169,361 B1, U.S. Pat. No. 9,193,835 B1, U.S. Pat. No. 9,469,733 B2, U.S. Pat. No. 9,162,189 B1, U.S. 2016/319158 A1, U.S. 2009/0173694, U.S. Pat. No. 9,527,041,

Traditionally, for block copolymer self-assembly, standard linear block copolymers and a single chemistry/configuration/structure in or adjacent to each block are envisaged. Thus, self-assembly is not described or viewed outside of linear arrangement of the block copolymers with a single chemistry/configuration/structure. However, in an aspect of the invention discussed below, complex block and copolymer architectures, possessing non-linear block arrangement, i.e., architecture with more than one chemistry/configuration/structure in or adjacent to at least one block will yield well-defined final porous structures from self-assembly. The complex architecture in or adjacent to at least one block of the copolymer enables tuning of the chemistry, physical properties, and self-assembly behavior.

### SUMMARY OF INVENTION

The invention involves porous self-assembled block copolymer materials. A portion of the pores are “isoporous”: having a substantially narrow pore diameter distribution. The self-assembled isoporous materials are comprised of block copolymers with a complex block structure or complex block architecture. In this context, a “complex” block structure or polymer architecture signifies more than one monomer, chemistry, configuration, or structure in at least one block, or adjacent to blocks. A combination of different block copolymer starting materials is another complex architecture of the invention. Complex block and block copolymer architectures can be used to tune the chemistry, physical properties, and self-assembly properties of the porous materials.

The invention also includes a method of producing the porous self-assembled block copolymer materials using complex block structure or complex block copolymer architecture. The method involves dissolving the complex block copolymer materials in at least one solvent, evaporating at least a portion of the solvent, and exposing the material to at least one non-solvent. In an embodiment, at least a portion of the nonsolvent is miscible with the chemical solvent and at least a portion of the BCP is immiscible in the nonsolvent.

The invention also involves using the isoporous self-assembled block copolymer materials for separations, as sensors, or as components of other devices.

### BRIEF DESCRIPTION OF DRAWINGS

FIG. 1 is a schematic of different complex block architectures where each of FIG. 1a (10), FIG. 1b (20), FIG. 1c (30), FIG. 1d (40), FIG. 1e (50), FIG. 1f (60), FIG. 1g (70), FIG. 1h (80), and FIG. 1i (90) correspond to different complex block architecture materials in accordance with the invention. In FIG. 1, different shades and/or line styles (e.g., solid line, dashed line) indicate configurationally, structurally, or chemically distinct regions.

FIG. 2 illustrates various block copolymer architecture materials FIG. 2a (100), FIG. 2b (110), FIG. 2d (120), FIG. 2e (130), and FIG. 2c (140), in accordance with the invention. The different shades and/or line styles (e.g., solid line, dashed line) indicate configurationally, structurally, or chemically distinct regions.

FIG. 3, illustrates various block copolymer architecture materials FIG. 3a (150), FIG. 3b (160), FIG. 3c (170) and FIG. 3d (180), in accordance with the invention. Different shades and line styles (e.g., solid line, dashed line) indicate configurationally, structurally, or chemically distinct regions.

FIG. 4 illustrates various block copolymer architecture materials in accordance with the invention, FIG. 4a (200), FIG. 4b (210), FIG. 4c (220), FIG. 4d (230), FIG. 4e (240), and FIG. 4f (250). The different shades and/or line styles (e.g., solid line, dashed line) indicate configurationally, structurally, or chemically distinct regions.

FIG. 5 schematically illustrates the synthesis of star block copolymer in accordance with the invention. A multifunctional initiator and first block on each of eight arms (260) is grown to form a star polymer (270) (FIG. 5a); a second monomer addition to the star polymer (270) (step 300) yields a second block (305) forming a diblock star structure (280) (FIG. 5b); a third monomer addition (step 310) yields third block (320), generating the star polymer where each arm contains the three different blocks (330) (FIG. 5c). The different shades and/or line styles (e.g., solid line, dashed line) indicate configurationally, structurally, or chemically distinct regions.

FIG. 6 shows scanning electron microscope images of A) self-assembled isoporous poly(isoprene-b-styrene-b-4-vinylpyridine) (ISV) material (comparative example), B) self-assembled isoporous ISV/poly(isoprene-b-styrene-b-2-hydroxyethyl methacrylate) (ISH) material with 9:1 ISV:ISH ratio by mass, C) self-assembled porous ISV/ISH material with a 6:4 ISV:ISH ratio by mass.

FIG. 7 shows a scanning electron microscope image of a self-assembled isoporous material comprising poly(styrene-b-4-vinylpyridine) and poly(isoprene-b-styrene-b-4-vinylpyridine).

FIG. 8 shows a scanning electron microscope image of a self-assembled isoporous material comprising poly(isoprene-b-styrene-b-2-vinylpyridine-random-4-vinylpyridine).

FIG. 9 shows a scanning electron microscope image of a self-assembled isoporous material comprising poly(isoprene-b-styrene-b-2-vinylpyridine-b-2-vinylpyridine-random-4-vinylpyridine), wherein the 2-vinylpyridine “block” is a short junction block of just a few monomer units.

FIG. 10 shows a scanning electron microscope image of a self-assembled isoporous material comprising poly(isoprene-b-styrene-random-isoprene-b-4-vinylpyridine).

FIG. 11 depicts a schematic of a separation device comprising a self-assembled isoporous material comprising at least one BCP comprising a complex architecture (350). The device comprises an inlet (340) for the medium to be separated, and an outlet (360) for the separated media to exit.

FIG. 12 depicts a schematic of a sensor device comprising a self-assembled isoporous material comprising at least one BCP comprising a complex architecture (350). The device comprises an inlet (340) for the medium to be separated, and an outlet (360) for the separated media to exit, as well as sensors (370) such as electrodes to detect an analyte of interest. Also depicted is an optional retentate port (345) for use in a crossflow configuration.

FIG. 13 shows a scanning electron microscope image of a self-assembled isoporous material comprising poly(isoprene-b-styrene-b-4-vinylpyridine)-OH. Also depicted is an optional retentate port (345) for use in a crossflow configuration.

### DETAILED DESCRIPTION OF THE INVENTION

The invention is a porous material comprising a block copolymer or block copolymers (BCPs) with a complex block copolymer architecture, wherein at least a portion of the pores are isoporous (having a substantially narrow pore diameter distribution). Specifically, the block copolymer architecture is not limited to linear block copolymers with a single monomer/chemistry/configuration/structure in each block, or adjacent to blocks. Any block copolymer architecture/topology that allows incompatible segments of the block copolymer to phase separate (self-assemble) into distinct domains, and be processed to generate porous block copolymer materials comprising isopores, is suitable for the invention. A method of making the materials provides one way of generating the porous materials which comprise at least one block copolymer with a complex architecture. The complex architecture/topology is present in the polymer system during the self-assembly process. Complex block and block copolymer architectures can be used to tune the chemistry, physical properties, and self-assembly properties of the mesoporous materials.

The typical usage of the term “block copolymer” refers to the simplest block copolymers which comprise two or more linear segments or “blocks” wherein adjacent segments include different constituent units, with only one constituent unit in each block. However, this simple architecture is not the only architecture that can result in self-assembly on the nano- and meso-scales or isoporosity. Such architectures, which will be referred to as complex block or copolymer architectures, can include, for example, intermediate distinct units between blocks (junction blocks) and varying end groups at the termini of chains. Even more complex block architectures and block copolymer architectures exist, wherein at least a portion of one block or at least a portion of one junction block or one or more end group comprises a structure or composition more complex than a linear single constituent unit chain. Such complex architectures include but are not limited to: periodic or random mixtures of different constituent units in one or more blocks, graft copolymer blocks, ring blocks or block copolymers, gradient blocks, or crosslinked blocks. Any block copolymer architecture/topology that allows incompatible segments of the block copolymer to phase separate (self-assemble) into distinct domains and could be processed using the method of the invention to generate porous block copolymer materials, is suitable for the invention.

Block selection can be based on desired material property or properties. Some of these properties could be intrinsic to the architecture, or the architecture could be modified to include them. These properties may include at least one of: a low Tg (25° C. or less) block, a high Tg (more than 25° C.) block, a hydrophilic block, a hydrophobic block, a chemically resistant block, a chemically responsive block, a chemically functional block. The table below correlates a stated or desired property and some potential polymer blocks.

The following Table provides properties and polymer/block chemistries for respective properties. The polymers/chemistries listed are nonlimiting examples and polymers/chemistries may have multiple different desired properties:

| Property | Polymer/block chemistry |
|---|---|
| Low Tg (25° C. | Poly(isobutylene), Poly(isoprene), Poly(butadiene), |
| or less) | Poly(propylene glycol), Poly(ethylene oxide), |
| | Poly(dimethylsiloxane) |
| High Tg (more | Poly(ethersulfone), Poly(sulfone), Poly(hydroxy- |
| than 25° C.) | styrene), Poly(methylstyrene) |
| Hydrophilic | Poly(ethylene glycol), Poly(2-hydroxyethyl |
| | methacrylate), Poly(acrylamide), Poly(N,N- |
| | dimethylacrylamide), Poly(propylene oxide), |
| | Poly(styrene sulfonate) |
| Hydrophobic | Poly(styrene), Poly(ethylene), Poly(vinyl chloride), |
| | Poly(2-(perfluorohexyl)ethyl methacrylate) |
| Chemically | Poly(tetrafluoroethylene), Poly(vinylidene fluoride), |
| resistant | Poly(pentafluorostyrene) |
| Chemically | Poly(acrylic acid), Poly(2-vinylpyridine), Poly(4- |
| responsive | vinylpyridine), Poly(3-vinylpyridine), Poly(N- |
| | isopropylacrylamide), Poly(dimethylaminoethyl |
| | methacrylate) |
| Chemically | Poly(glycidyl methacrylate), Poly(ethyleneimine), |
| functional | Poly(lactic acid), Poly(acrylonitrile), Poly(methyl |
| | acrylate), Poly(butyl methacrylate), Poly(methyl |
| | methacrylate), Poly(n-butyl acrylate), Poly(amic acid), |
| | Poly(isocyanate), Poly(ethyl cyanoacrylate), |
| | Poly(allylamine hydrochloride), Poly(methacrylic acid) |

Additional more specific desirable properties include, but are not limited to: fluorination, pH responsivity, thermal responsivity, ionic strength responsivity, electrostatically charged, ion conductivity, electron conductivity, sulfonation.

Alternatively, or in addition to selecting the block based on properties, suitable blocks include, Poly [(C₂-C₆) unsaturated, cyclic or non-cyclic, aromatic or non-aromatic hydrocarbons], e.g., Poly(butadiene), Poly(isobutylene), Poly(butylene), Poly(isoprene), Poly(ethylene), Poly(styrene); Poly((C₂-C₆) substituted, non-substituted acrylates), e.g., Poly(methyl acrylate), Poly(butyl methacrylate), Poly(methyl methacrylate), Poly(n-butyl acrylate), Poly(2-hydroxyethyl methacrylate), Poly(glycidyl methacrylate), Poly(dimethylaminoethyl methacrylate), Poly(acrylic acid), Poly(2-(perfluorohexyl)ethyl methacrylate), Poly(ethyl cyanoacrylate); Poly [(C₂-C₆) substituted, unsaturated, cyclic or non-cyclic, aromatic or non-aromatic compounds], Poly(ethylene sulfide), Polypropylene sulfide).

Suitable block copolymers include those with a number average molecular weight (Mₙ) of about 1×10³ to 1×10⁷ g/mol. In an embodiment, the Mₙ is in the range of about 1×10³ to 1×10⁷ g/mol. In an embodiment, the Mₙ is in the range of about 1×10³ to 5×10⁶ g/mol. In an embodiment, the Mₙ is in the range of about 1×10⁴ to 1×10⁷ g/mol. In an embodiment, the Mₙ is in the range of about 1×10⁴ to 5×10⁶ g/mol. In an embodiment, the Mₙ is in the range of about 1×10⁴ to 3×10⁶ g/mol. Suitable block copolymers also include those wherein the PDI (polydispersity index) is 1.0 to 3.0. In an embodiment, the PDI is in the range of 1.0 to 3.0. In an embodiment, the PDI is in the range of 1.0 to 2.5. In an embodiment, the PDI is in the range of 1.0 to 2.0. In an embodiment, the PDI is in the range of 1.0 to 1.5. Suitable block copolymers also include diblock copolymers, triblock copolymers, or polymers blocks of higher order (i.e. tetrablock, pentablock, etc.).

Any synthetic method for generating the block copolymer or block copolymers comprising the invention is suitable, as long as incompatible segments can self-assemble into discrete domains and be processed to generate isoporous block copolymer materials. For example, suitable synthetic methods for the polymers include, but are not limited to: anionic polymerization, cationic polymerization, step growth polymerization, oligomer polycondensation, ring opening polymerization, controlled radical polymerization, and reversible addition-fragmentation chain-transfer polymerization.

The porous material has a layer having a thickness of from about 5 nm to about 500 nm, in unit (nm) increments and ranges therebetween, and a plurality of mesopores about 1 nm to about 200 nm in diameter, in said layer. In an embodiment, the mesopores are in the range of about 1 nm to about 200 nm. In an embodiment, the mesopores are in the range of about 3 nm to about 200 nm. In an embodiment, the mesopores are in the range of about 5 nm to about 200 nm. In an embodiment, the mesopores are in the range of about 5 nm to about 100 nm. In an embodiment, the mesopores are in the range of about 10 nm to about 100 nm. The material may also have a bulk layer having a thickness of from about 2 microns to about 500 microns, unit (μm) increments and ranges therebetween, including macropores having a size of from about 200 nm to about 100 microns. One application of this invention is as a device. One such device is a separation device. Another such device is a sensor device.

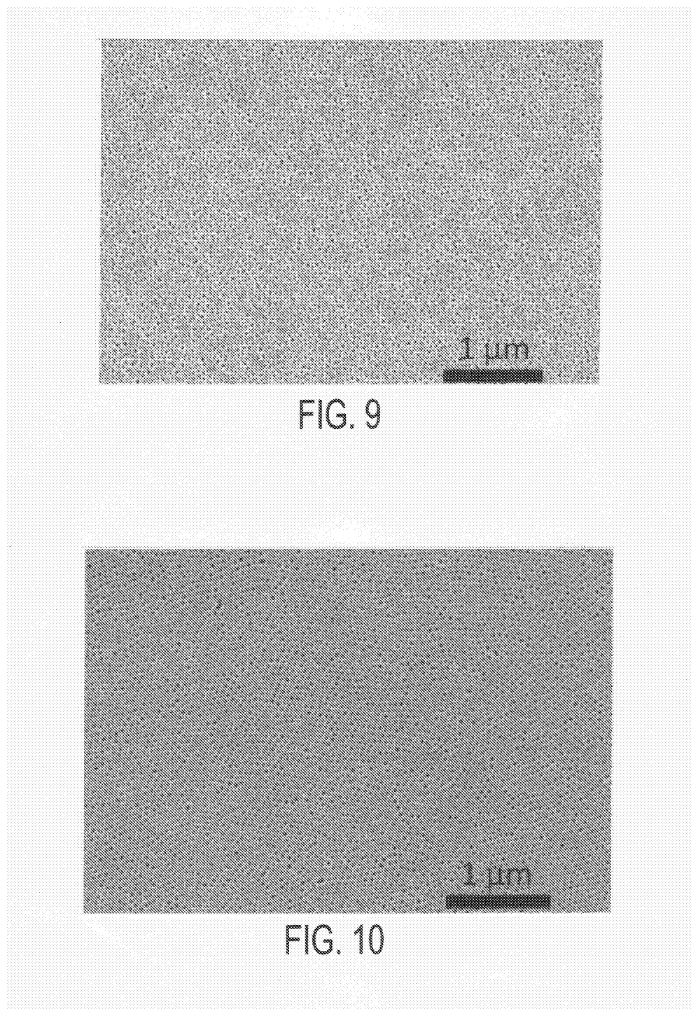

In one embodiment, at least one BCP comprising the porous material has at least one block comprising two or more different monomer types, differing with respect to structure, chemistry, or configuration. In this embodiment, at least a portion of at least one BCP comprises more than one distinct monomer type in at least one block, between blocks, or at the end of at least one block. One example is a BCP comprising at least one statistical/random block wherein there is a random/statistical distribution of the different monomers in the block, e.g., [A-random-B], where [A-random-B] represents a polymer block comprising a random distribution of monomer units A and B. Another example, as exemplified in ¶[0060] and FIG. 8, has a BCP with a block comprising a random mixture of distinct monomers wherein the monomers differ in that they are isomers of vinylpyridine (e.g. poly(isoprene-b-styrene-b-2-vinylpyridine-random-4-vinylpyridine). Another example, as exemplified in ¶[0062] and FIG. 9, has a BCP comprising a block with a mixture of distinct monomers, wherein the distinct monomers are isomers of vinylpyridine, as well as a junction block as described in ¶[0036], (e.g. poly(isoprene-b-styrene-b-2-vinylpyridine-b-2-vinylpyridine-random-4-vinylpyridine), wherein the 2-vinylpyridine “block” is a short junction block of just a few monomer units). Another example, as exemplified in ¶[0064] and FIG. 10, has a BCP comprising a block with mixed monomers, varying by monomer chemistry: isoprene and styrene (e.g. poly(isoprene-b-styrene-random-isoprene-b-4-vinylpyridine)).

Another example is a BCP comprising at least one tapered BCP block wherein only a part of the block has a monomer gradient, e.g., [A]-[A-gradient-B]-[B]. A and B represent different monomer units. [A] and [B] represent polymer blocks comprised solely of monomer A and solely monomer B, respectively. The [A-gradient-B] monomer gradient implies the beginning segment of the chain/block contains a high frequency of monomer A and a low frequency of monomer B; across incremental segments of the gradient, the frequency of monomer A decreases while the frequency of monomer B increases; at the end segment of the gradient, there is a low frequency of monomer A and a high frequency of monomer B. The gradient portion of the block can also be considered a transitional block between two ungraded blocks. For example, the [A-gradient-B] component of this system moves from a polymer region containing a higher concentration of A component relative to B component to a polymer region containing a higher concentration of B component relative to A component.

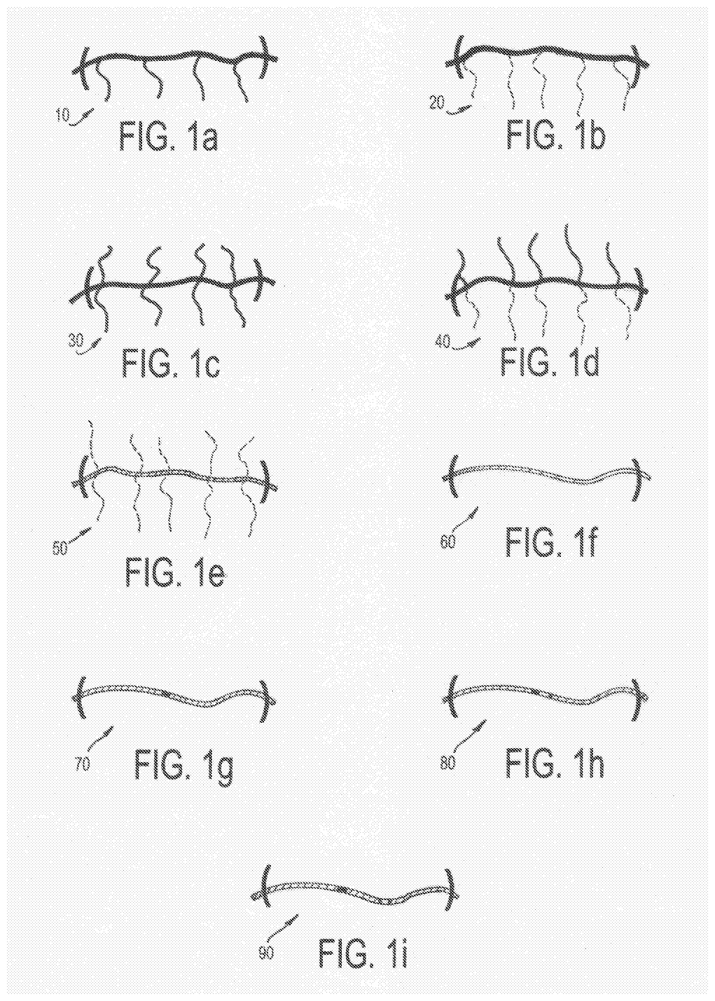

Another example (as shown in FIG. 1f) is a gradient BCP block, wherein at least one BCP comprises at least one block where the entire block has a monomer gradient, e.g., [A-gradient-B].

Another example is a BCP comprising at least one alternating/periodic block wherein the different monomers have an ordered sequence, e.g., [A-B-A-B-. . . ], [A-B-C-A-B-C-. . . ], [A-A-B-A-A-B-. . . ], etc. A, B, and C represent different monomer units. The square bracketed examples represent polymer blocks wherein the monomer sequence is repeated throughout the block. Examples of monomer units described above include but are not limited to, A=isoprene, B=ethylene oxide, C=styrene. One application of this embodiment is the tuning of the BCP material's mechanical properties by including monomers with different mechanical properties in at least one block. Another application of this embodiment is the addition of functional groups to a portion of the BCP material. Another application of this embodiment is the incorporation of different monomers into a block to influence the phase separation behavior during self-assembly.

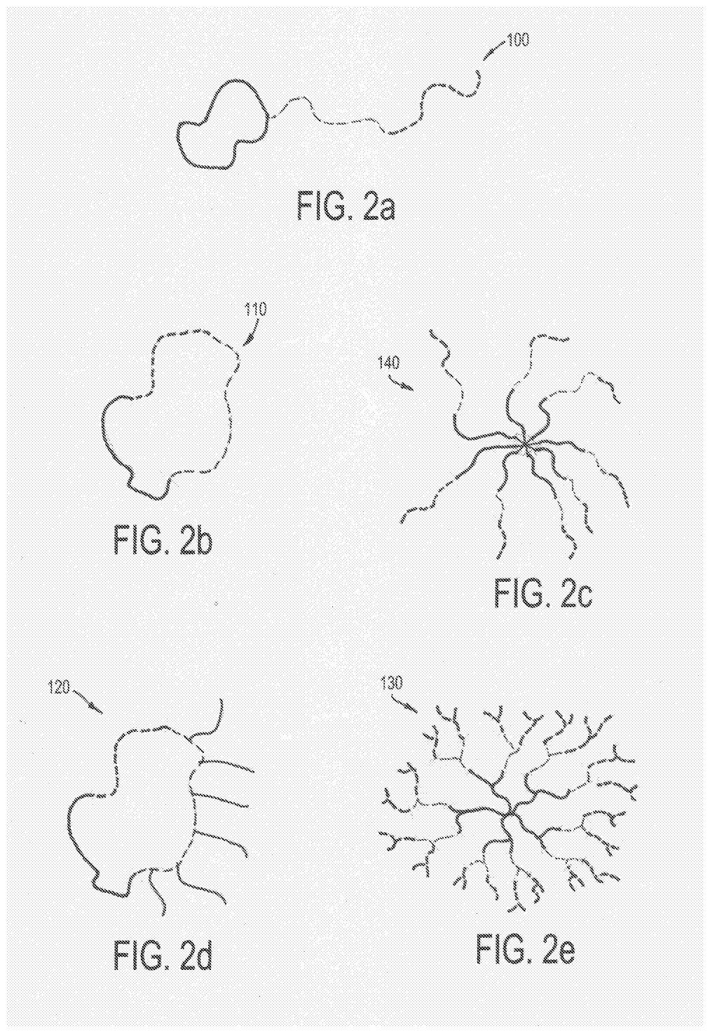

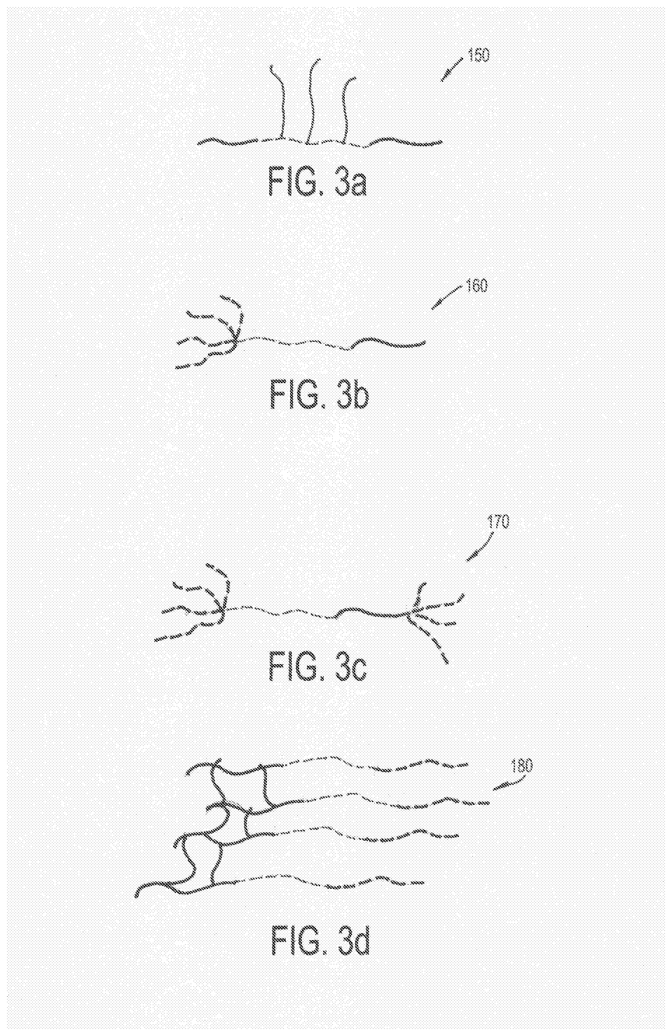

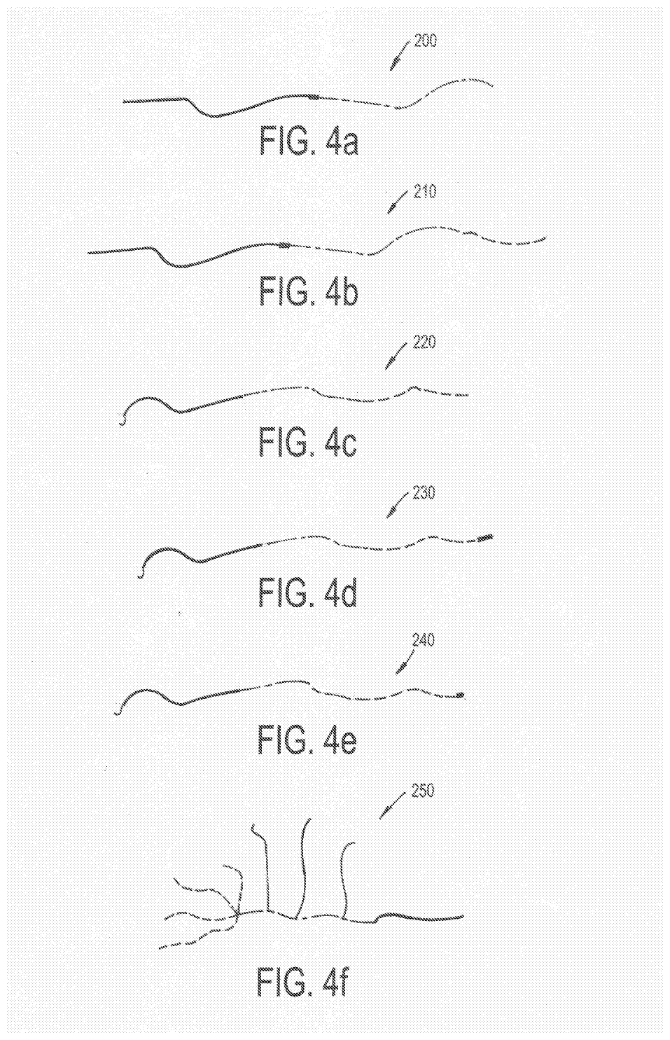

In another embodiment, the BCP comprising the porous material comprises at least a portion of at least one block that is branched wherein at least one substituent on a monomer unit is replaced by another covalently bonded polymer chain. One example (as shown in FIG. 1a) is a BCP comprising at least one branched block, wherein the branched block is partially or completely substituted with polymer chains of the same monomer structure, chemistry, and configuration as the main chain (e.g., branched poly(ethylene)). Another example (as shown in FIG. 1b, FIG. 3a, or FIG. 4f) is a BCP comprising at least one grafted block, wherein the grafted block is partially or completely substituted with polymer chains of a different monomer structure, chemistry, or configuration from the main chain (e.g., poly(styrene) branched from poly(butadiene)). Another example (as shown in FIG. 1c, FIG. 1d, or FIG. 1e) is a BCP comprising at least one comb/brush block, wherein at least a portion of the monomer units of the main chain of the brush/comb block are partially or completely branched with multiple side chains from a single branch point (e.g., multiple poly(butadiene) chains branched from a poly(styrene) backbone). The side chains are either different in part or in whole from or the same as the main chain with respect to structure, chemistry, or configuration. Another example (as shown in FIG. 2c or FIG. 5c) is a symmetric or asymmetric star BCP, wherein the BCP comprises a single branch which gives rise to multiple linear chains (arms) (e.g., poly(isoprene-b-styrene-b-4-vinylpyridine) wherein each arm is a linear triblock terpolymer, with poly(isoprene) at the core). Another example (as shown in FIG. 2e) is a BCP comprising at least one dendritic block, wherein all or at least a portion of the monomer units of the dendritic block are repetitively branched (substituted with polymer chains of the same as or different from the monomer structure, chemistry, and configuration of the main chain) (e.g., hyperbranched poly(ethyleneimine)). Another example (as shown in FIG. 3b, FIG. 3c, FIG. 4f) is a BCP comprising at least one block which is composed solely of chains branched from a single point of another block or linker adjacent to a block (e.g., poly(lactic acid) arms branching from poly(ethylene oxide)). Another example (as shown in FIG. 3d) is a BCP comprising at least one crosslinked block, wherein all or at least a portion of the monomer units of the crosslinked block are covalently attached to other polymer chains within the same BCP macromolecule or other BCP macromolecules (e.g., crosslinked poly(glycidyl methacrylate)). One application of this embodiment is enabling crosslinking of the material through the inclusion of a crosslinkable (e.g., double-bond containing) branch chain on at least one block. Another application of this embodiment is altering the self-assembly behavior of the porous material, e.g., pore packing geometry, pore sizes, porosity, layer thickness, due to the differing self-assembly behavior of branched or crosslinked BCPs compared to linear analogues.

In another embodiment, at least a portion of at least one BCP comprising the porous material has a macromolecular ring architecture (i.e., a macromolecular portion of the chain is in a ring architecture, not simply a small molecular ring such as a phenyl ring or a heterocyclic ring). One example (as shown in FIG. 2a) is a BCP in which at least one block has a cyclic/ring architecture (e.g., poly(cyclic styrene-b-acrylic acid)). Another example (as shown in FIG. 2b or 2d) is a BCP in which the entire BCP comprises a macromolecular ring architecture (e.g., cyclic poly(ethylene oxide-b propylene oxide)). One application of this embodiment is altering the pore density due to the different self-assembly behavior and micellization of ring BCPs compared to their linear counterparts. For example, macromolecular ring architectures can have higher areal pore densities at a given molecular weight compared to non-complex linear BCPs.

In another embodiment, at least one BCP comprising the porous material comprises at least one distinct unit between at least one pair of blocks. These may be considered junction blocks. An example is a BCP wherein a single unit of a configurationally, structurally, or chemically distinct unit is covalently bonded between at least one pair of blocks, e.g., [A]-C-[B]. Another example is a BCP wherein a single unit, each, of two configurationally, structurally, or chemically distinct units are covalently bonded between at least one pair of blocks, e.g., [A]-C-D-[B]. Another example (as shown in FIG. 4a or FIG. 4b) is a BCP wherein multiple units of a configurationally, structurally, or chemically distinct unit are covalently bonded between at least one pair of blocks, e.g., [A]-C-C-C-[B], [A]-C-C-C-[B]-[D]. Another example is a BCP wherein multiple units of configurationally, structurally, or chemically distinct units are covalently bonded between at least one pair of blocks [A]-C-C-C-D-D-[B]. Another example is a BCP wherein a single unit of one configurationally, structurally, or chemically distinct unit, and multiple units, of another configurationally, structurally, or chemically distinct unit are covalently bonded between at least one pair of blocks, e.g., [A]-C-D-D-D-[B]. In these examples, [A] represents a polymer block comprising solely monomer A units; [B] represents a polymer block comprising solely monomer B units; unbracketed C and D represent individual monomer units of C and D respectively; chemical bonds are represented by connecting hyphens. Examples of monomer units described above include but are not limited to, A=methyl methacrylate, B=dimethylsiloxane, C=ethylene oxide, D=acrylonitrile. One application of this embodiment is generating a cleavable surface block which tunes the pore size; this is achieved by including a cleavable unit between blocks, which can be cleaved after the BCP is formed into a porous material. Another example, as exemplified in ¶[0062] and FIG. 9, has a BCP comprising a block with a mixture of distinct monomers, wherein the distinct monomers are isomers of vinylpyridine as described in ¶[0030], as well as a junction block as described in this paragraph (e.g. poly(isoprene-b-styrene-b-2-vinylpyridine-b-2-vinylpyridine-random-4-vinylpyridine), wherein the 2-vinylpyridine “block” is a short junction block of just a few monomer units).

In another embodiment, the BCP comprising the porous material comprises at least one block with at least one additional distinct unit. An example is a BCP wherein a single unit of a configurationally, structurally, or chemically distinct unit is covalently bonded within at least one block, e.g., [A]-B-[A]. Another example is a BCP wherein a single unit of each of two configurationally, structurally, or chemically distinct units are covalently bonded within at least one block. The two different units may or may not be adjacent within the block, e.g., [A]-B-C-[A], [A]-B-[A]-C-[A]. Another example (as shown in FIG. 1g) is a BCP wherein multiple units of a configurationally, structurally, or chemically distinct unit are covalently bonded within at least one block, e.g., [A]-B-B-B-B-[A]. Another example (as shown in FIG. 1h or FIG. 1i) is a BCP wherein multiple units of configurationally, structurally, or chemically distinct units are covalently bonded within at least one block, e.g., [A]-B-B-B—C-C-C-C-[A], [A]-B-B-B-B—C-C-C-C-[A], [A]-B-B-B-[A]-C-C-C-C-C-[A]. Another example is a BCP wherein a single unit of one configurationally, structurally, or chemically distinct unit, and multiple units, of another configurationally, structurally, or chemically distinct unit are covalently bonded in at least one block; the different units may or may not be adjacent to one another, e.g., [A]-B—C-C-C-[A], [A]-B-[A]-C-C-C-[A]. In these examples, [A] represents a polymer block comprising solely monomer A units; unbracketed A, B, and C represent individual monomer units of A, B, and C respectively; chemical bonds are represented by connecting hyphens. Examples of monomer units described above include but are not limited to, A=hydroxystyrene, B=2-vinylpyridine, C=2-hydroxyethyl methacrylate. One application of this embodiment is generating a partially cleavable block which tunes the material's pore size, while retaining the block's surface chemistry; this is achieved by including a cleavable unit within a block, which can be cleaved after porous material fabrication.

In another embodiment, the BCP comprising the porous material comprises at least one distinct unit covalently bonded to at least one chain end of the BCP. An example is a BCP wherein a single unit of a configurationally, structurally, or chemically distinct unit is covalently bonded to at least one chain terminus, e.g., D-[A]-[B]-[C], D-[A]-[B]-[C]-D. One such example, as exemplified in ¶[0069] and FIG. 13, has a BCP with a single distinct unit (—OH) at the terminus of poly(isoprene-b-styrene-b-4-vinylpyridine), that is, having the structure poly(isoprene-b-styrene-b-4-vinylpyridine)-OH. Another example (as shown in FIG. 4c or FIG. 4d) is a BCP wherein multiple units of a configurationally, structurally, or chemically distinct unit is covalently bonded to at least one chain terminus, e.g., D-D-D-D-[A]-[B]-[C], D-D-D-D-[A]-[B]-[C]-D-D-D. Another example is a BCP wherein single units of more than one configurationally, structurally, or chemically distinct units are covalently bonded to different chain termini, e.g., D-[A]-[B]-[C]-E. Another example (as shown in FIG. 4e) is a BCP wherein multiple units of configurationally, structurally, or chemically distinct units are covalently bonded to different chain termini, e.g., D-D-D-[A]-[B]-[C]-E-E-E. Another example is a BCP wherein multiple units of configurationally, structurally, or chemically distinct units are covalently bonded to one terminus and a configurationally, structurally, or chemically distinct unit is covalently bonded to a different chain terminus, e.g., D-[A]-[B]-[C]-E-E-E. In these examples, [A] represents a polymer block comprising solely monomer A units; [B] represents a polymer block comprising solely monomer B units; [C] represents a polymer block comprising solely monomer C units; unbracketed D and E represent individual monomer units of D and E respectively; chemical bonds are represented by connecting hyphens. Examples of monomer units described above include but are not limited to, A=n-isopropylacrylamide, B=butadiene, C=α-methylstyrene, D=acrylamide, E=isocyanate. One application of this embodiment is enabling further complex BCP architectures through the attachment of another molecule or macromolecule at the terminus/termini; this is achieved through a reactive functional unit on the terminus/termini which is reacted with another reactive functionality on the molecule or macromolecule that is to be attached.

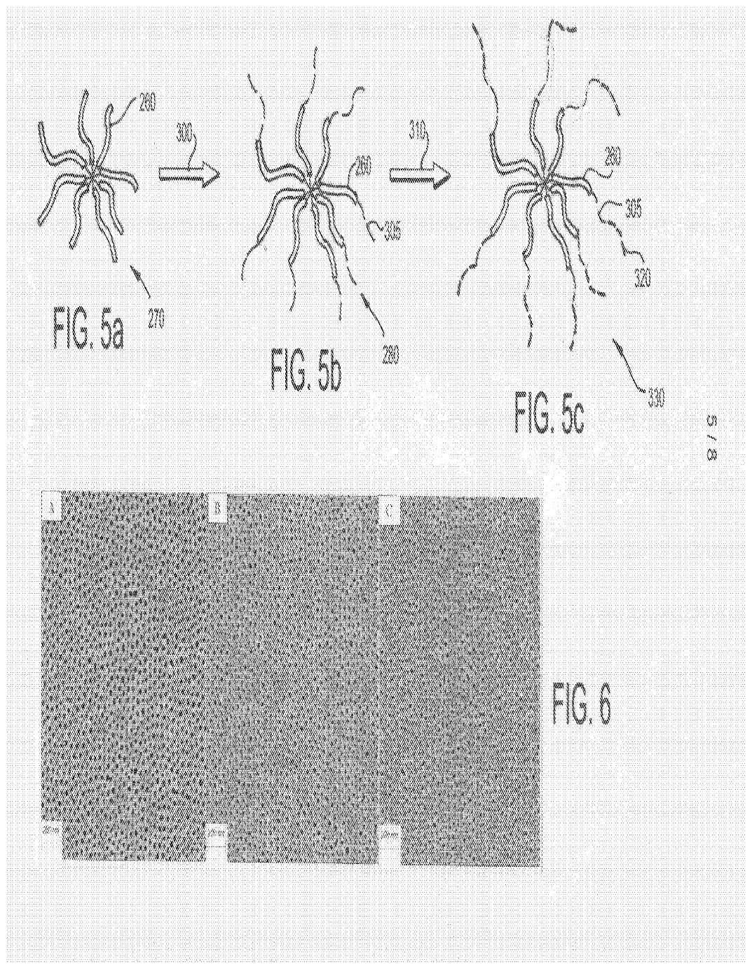

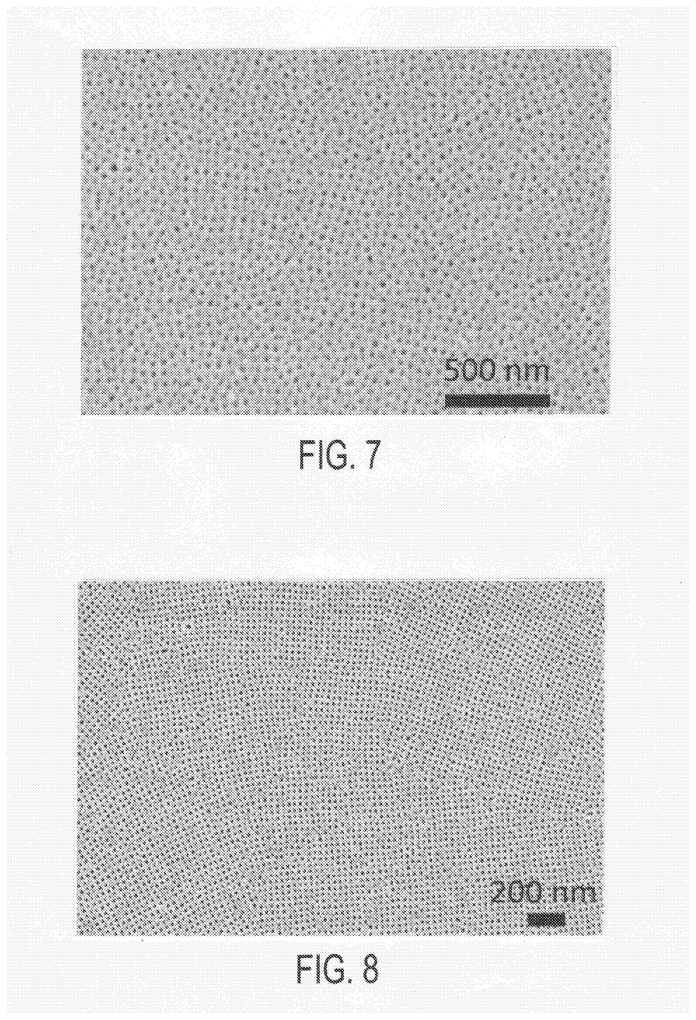

In another embodiment, the polymer comprising the porous material comprises more than one BCP. One example is a blend of more than one BCP of the same chemical composition but different sizes (e.g., 124 kg/mol poly(isoprene-b-styrene-b-4-vinylpyridine), 30% poly(isoprene), 55% poly(styrene), 15% poly(4-vinylpyridine); blended with 366 kg/mol poly(isoprene-b-styrene-b-4-vinylpyridine), 30% poly(isoprene), 55% poly(styrene), 15% poly(4-vinylpyridine)). Another example is a blend of more than one BCP comprising different chemical compositions but the same size (e.g., 150 kg/mol poly(isoprene-b-styrene-b-2-vinylpyridine) blended with 150 kg/mol poly(isoprene-b-styrene-b-2-hydroxyethyl methacrylate)). Another example, as exemplified in ¶[0057] and FIG. 6, is a blend of more than one BCP of different chemical composition but similar size (e.g. poly(isoprene-b-styrene-b-4-vinylpyridine) 74.6 kg/mol, and poly(isoprene-b-styrene-b-2-hydroxyethyl methacrylate) 74.3 kg/mol). Another example, as exemplified in ¶[0058] and FIG. 7, is a blend of more than one BCP of different chemical composition and different size (e.g. poly(styrene-b-4-vinylypyridine), 142 kg/mol and poly(isoprene-b-styrene-b-4-vinylpyridine), 167 kg/mol). Another example is a blend of more than one BCP of the same chemical composition but different architectures (e.g., poly(styrene-gradient-ethylene oxide) blended with cyclic poly(styrene-b-ethylene oxide)). Another example is a blend comprising more than one BCP comprising different chemical compositions, different sizes, and different architectures. (e.g., 119 kg/mol poly(isoprene-b-styrene-b-4-vinylpyridine) blended with 20 kg/mol poly(hydroxystyrene-b-butadiene-graft-styrene) and 76 kg/mol poly(ethylene oxide-b-vinyl chloride). One application of this embodiment is the tuning of the material's pore size or chemistry through blends of BCPs of different sizes and/or compositions.

As an example, achieving self-assembly in a system a high chi parameter is desirable. The chi (interaction) parameter is a measure of the interaction between different molecules and can predict whether molecules or blocks phase segregate during self-assembly. If the chi parameter is not high enough between two adjacent blocks in a block copolymer, self-assembly from phase separation will not occur. When blocks that are used to provide various functional features of the membrane (e.g., hydrophilicity, thermal resistance, chemical functionality, etc.) exhibit low chi parameters relative to each other, their self-assembly may be inhibited. A block may be adapted to form a complex architecture to increase the relative chi parameter and facilitate self-assembly of the system. As a specific example, poly(styrene-b-methyl methacrylate) may be used where poly(styrene) can provide an economical material to serve as a matrix while poly(methyl methacrylate) can provide a functionality for covalent material modification. Poly(styrene) and poly(methyl methacrylate) are known to self-assemble in bulk systems, although they do so in a phase space of low segregation wherein the chi parameter is <0.1. In the fabrication of isoporous membranes, the presence of various solvent components may further decrease the chi parameter, which is a key driving force in the self-assembly of the block copolymer. In order to facilitate self-assembly and thus the fabrication of isoporous materials, a complex architecture incorporating a component of a block that increase the chi parameter between adjacent blocks is implemented. In the example above, dimethylsiloxane is incorporated into the poly(methyl methacrylate) block to increase the chi parameter.

In another example, certain chemistries in a block provide different features in the final membrane. In a poly(styrene-b-4-vinylpyridine) system, the 4-vinylpyridine component provides a pH-responsive surface that can be used as, e.g., an actuator or gate. However, synthesis of poly(4-vinylpyridine) can be difficult at higher molecular weights, limiting the average feature size (e.g., pore size) of the resulting isoporous material. To increase the molecular weight of the poly(4-vinylpyridine) block, another monomer chemistry such as poly(2-vinylpyridine), which can be synthesized to higher molecular weights more readily, is incorporated into the block to form a complex architecture and enable larger feature sizes. The presence of 2-vinylpyridine during the poly(4-vinylpyridine) polymerization prevents side reactions and prevents decreased solubility in the solvent, both of which limit the molecular weight of the block in the absence of 2-vinylpyridine.

In another example, certain block chemistries may have a high solubility in the plunging solvent or coagulation solvent that is used in the fabrication of the isoporous material. For example, poly(ethylene oxide) is highly soluble in water, which can be used as a precipitation or coagulation solvent during membrane fabrication. This solubility makes precipitation and/or solidification of the polymer challenging. By adding another monomer chemistry to the poly(ethylene oxide) block to form a complex architecture, (e.g., styrene monomer), the hydrophilic feature of the poly(ethylene oxide) block is maintained while enabling the polymer solution to precipitate in the bath and form a solid structure.

In another example, it may be desirable to have a high glass transition temperature component to a block to facilitate membrane operation or processing at elevated temperatures. For example, a poly(isoprene) block has a glass transition temperature on the order ranging from ˜−60° C.-0° C. depending on the monomer configuration. To increase the potential operating temperature of this block, an additional monomer chemistry may be incorporated in the poly(isoprene) block (e.g., styrene, α-methylstyrene, acrylamide, methyl methacrylate, etc.) to form a complex architecture that would increase the glass transition temperature of the overall block. This enables the material to be used at room temperature or above. Similarly, the incorporation of even higher glass transition temperature monomers to form complex blocks allows for the use or processing of the isoporous materials at temperatures suitable for high temperature chemical separations or high temperature sterilizing processes.

In another example, it may be desirable to have a partially or completely optically transparent porous material. Such optical transparency allows observation through the material, for example observing the permeate through a membrane or monitoring fouling through a membrane's depth during filtration. To achieve this, a block copolymer comprising at least one region with a gradient architecture can be used. The gradient architecture induces less distinct or abrupt interfaces during self-assembly of a block copolymer due to the gradual compositional change across the graded region. The “fuzzier” phase separation interfaces result in decreased light scattering and more optically transparent materials than abrupt phase separation interfaces. An example of a gradient block that reduces optical scattering is poly(isoprene-gradient-styrene).

In another example, it is desirable to control the chemical response of a porous material's surface. Poly(4-vinylpyridine) is a pH responsive polymer and is used in pH responsive block copolymer membranes (e.g., poly(isoprene-b-styrene-b-4-vinylpyridine)). In some cases, the poly(4-vinylpyridine) block resides on the surface of the porous material. Upon protonation at low pH the positively charged poly(4-vinylpyridine) chains electrostatically repulse one another and close the pores, slowing or stopping membrane flux. It is desirable to control the extent of the pore closure, or to prevent significant effects of pH on flux while retaining the poly(4-vinylpyridine) surface chemistry (e.g., for chemical reaction at the pyridine nitrogen). To achieve this a block copolymer comprising a branched/dendritic block is used. The branched/dendritic structure hinders the extension of the poly(4-vinylpyridine) chains upon protonation and thus prevents complete pore closure. The extent of the branching and overall poly(4-vinylpyridine) block length are used to tune or prevent the pore closure upon protonation at low pH.

In some embodiments, the material of the invention is formed into a two-dimensional (e.g., sheet, film) or three-dimensional structure (e.g., tube, monolith). The material is asymmetric or symmetric in structure.

In some embodiments, the material of the invention, or a device comprising the material of the invention, is used in a process for filtration or separation. In one such embodiment, the material of the invention, or a device comprising the material of the invention, is used as a membrane or a filter.

In some embodiments, the material of the invention, or a device comprising the material of the invention, is used in a process for filtration or separation in liquids. In other embodiments, the material of the invention, or a device comprising the material of the invention, is used in a process for filtration or separation in gases.

In some embodiments, the material of the invention, or a device comprising the material of the invention, is used in a process for filtration, separation, or removal of one or more viruses from a liquid or gas.

In some embodiments, the material of the invention is packaged as a device including, for example: a pleated pack, flat sheets in a crossflow cassette, a spiral wound module, hollow fiber, a hollow fiber module, or as a sensor. In an embodiment, a device can utilize more than one different material of the invention.

In one embodiment, the material or device comprising the material of the invention has a detectable response to a stimulus/stimuli.

In some embodiments, the material of the invention, or a device comprising the material of the invention, is used in a process wherein an analyte of interest is separated in a medium containing the analyte of interest contacting the material or device. In one such process, the analyte of interest is separated by binding and eluting. In another such process, solutes or suspended particles are separated by filtration. In another such process, both bind and elute and separation by filtration mechanisms are incorporated.

In some embodiments, the material of the invention, or a device comprising the material of the invention, is used in a process wherein an analyte of interest is detected in a medium containing the analyte of interest contacting the material or device. In one such process, the analyte of interest is detected by a response of the material/device to the presence of the analyte of interest.

In some embodiments, more than one different material of the invention is packaged together as a kit. In other embodiments, more than one device comprising the material of the invention is packaged together as a kit.

In some embodiments, the material of the invention is immobilized to or integrated with a support or a textile.

One method for achieving the invention involves: dissolution of BCP in at least one chemical solvent; dispensing the polymer solution onto a substrate or mold, or through a die or template; removal of at least a portion of the chemical solvent; exposure to a nonsolvent causing precipitation of at least a portion of the polymer; optionally, a wash step. The chemical solvent is polar or nonpolar. At least a portion of the chemical solvent can include one of the following classes: alcohol (e.g., methanol, butanol, ethanol, propanol), aldehyde (e.g., acetaldehyde), alkane (e.g., hexane, cyclohexane), amide (e.g., dimethylformamide, dimethylacetamide), amine (e.g., pyridine), cyclic aromatic (e.g., toluene, benzene), carboxylic acid (e.g., acetic acid, formic acid), ester (e.g., ethyl acetate), ether (e.g., tetrahydrofuran, diethyl ether, dioxane), ketone (e.g., acetone), lactam (e.g., N-methyl-2-pyrrolidone), nitrile (e.g., acetonitrile), organohalide (e.g., chloroform, dichloromethane), polyol (e.g., dimethoxyethane), sulfone (e.g., sulfolane), or sulfoxide (e.g., dimethylsulfoxide).

### Example 1: An Example of the Embodiment Described in ¶[0039]

| | | ISV:ISH | ISV:ISH |
|---|---|---|---|
| | ISV | (9:1) | (6:4) |
| Permeability, L m⁻² h⁻¹ bar⁻¹ | 196 | 232 | 257 |
| Gamma Globulin Adsorption, μg/cm² | 308 | 217 | 83 |

Two block copolymers: poly(isoprene-b-styrene-b-4-vinylpyridine) (ISV, 74.6 kg/mol, 27.3% poly(isoprene), 52.4% poly(styrene), 20.3% poly(4-vinylpyridine), PDI=1.51) and poly(isoprene-b-styrene-b-2-hydroxyethyl methacrylate) (ISH, 74.3 kg/mol, 28.6% poly(isoprene), 58.9% poly(styrene), 12.5% pol(2-hydroxyethyl methacrylate), PDI=1.32) are mixed in different ratios and used to generate materials of the invention, and compared to pure ISV materials (comparative example). The ISV:ISH ratios were 9:1 and 6:4 by mass. Surprisingly, the ISV:ISH materials of the invention generated self-assembled porosity much like the pure ISV materials. Even more unexpectedly, the inclusion of the ISH with ISV significantly reduced the protein fouling compared to pure ISV porous materials. While pure ISV porous materials have a gamma globulin adsorption of 308 μg/cm², the 9:1 ISV:ISH materials have a gamma globulin adsorption of 217 μg/cm² and 6:4 ISV:ISH have a gamma globulin adsorption of 83 μg/cm². These represent 29.5% and 73.0% reductions in fouling (relative to pure ISV mesoporous materials, comparative example) with the inclusion of only 10% and 40% ISH, respectively, all while still allowing self-assembled porosity in the materials. The reduction in protein fouling is especially useful for preventing membrane fouling/clogging in the presence of protein, a common solute in biological and biopharmaceutical applications. Decreased fouling leads to higher membrane fluxes and extended membrane lifetimes. Furthermore, the water permeability of membranes from ISV:ISH porous materials of the invention were higher than pure ISV membranes. The pure ISV membrane (FIG. 6a) had a flux of 145 L m⁻² h⁻¹ bar⁻¹ (LMH/bar), the 9:1 ISV:ISH (FIG. 6b) has permeability of 232 L m⁻² h⁻¹ bar⁻¹ and the 6:4 ISV:ISH (FIG. 6c) has a permeability of 257 L m⁻² h⁻¹ bar⁻¹. Higher permeabilities allow more permeate to pass through the membrane in a given time frame.

### Example 2: An Example of the Embodiment in ¶[0039]

The isoporous material comprises a blend of multiple BCPs as described in ¶[0039]. The isoporous material comprises poly(styrene-b-4-vinylpyridine), 142 kg/mol, 86.6% poly(styrene), 13.4% poly(4-vinylpyridine), PDI=1.08 and poly(isoprene-b-styrene-b-4-vinylpyridine), 167 kg/mol, 24.8 wt % poly(isoprene), 57.8 wt % poly(styrene), 17.4 wt % poly(4-vinylpyridine), PDI=1.25. The polymers are dissolved at 10 wt % total in 7:3 1,4-dioxane:acetone and a 3:1 ratio of poly(isoprene-b-styrene-b-4-vinylpyridine): poly(styrene-b-4-vinylpyridine). The solution is dispensed, evaporates for 60 s, and is plunged into a water nonsolvent bath.

### Example 3: An Example of the Embodiment in ¶[0030]

BCP with a block comprising a mixture of distinct monomers, wherein the distinct monomers are isomers of vinylpyridine, as described in ¶[0030]. The isoporous material comprises poly(isoprene-b-styrene-b-2-vinylpyridine-random-4-vinylpyridine), 112 kg/mol 20.1 wt % poly(isoprene), 63.3 wt % poly(styrene), 16.6 wt % poly(vinylpyridines) with a 2-vinylpyridine:4-vinylpyridine ratio of 22:78, PDI=1.12. The polymer is dissolved at 15 wt % in 7:3 1,4-dioxane:acetone. The solution is dispensed, evaporates for 120 s, and is plunged into a water nonsolvent bath. An SEM image of the isoporous material is shown in FIG. 8.

### Example 4: An Example of the Embodiments in ¶[0030] and ¶[0036]

The isoporous material comprises a BCP comprising a block with a mixture of distinct monomers, wherein the distinct monomers are isomers of vinylpyridine as described in ¶[0030], as well as a junction block as described in ¶[0036]. The isoporous material comprises poly(isoprene-b-styrene-b-2-vinylpyridine-b-2-vinylpyridine-random-4-vinylpyridine), wherein the 2-vinylpyridine “block” is a short junction block of just a few monomer units. The polymer composition is: 94 kg/mol, 24.7 wt % poly(isoprene), 57.8% poly(styrene), 17.5% poly(vinylpyridines) with a 2-vinylpyridine:4-vinylpyridine ratio of 16:84, PDI=1.21. The polymer is dissolved at 10 wt % in 7:3 1,4-dioxane:acetone. The solution is dispensed, evaporates for 40 s, and is plunged into a water nonsolvent bath. An SEM image of the isoporous material is shown in FIG. 9.

### Example 5: An Example of the Embodiment in ¶[0030]

The isoporous material comprises a BCP comprising a block with mixed monomers, varying by monomer chemistry (isoprene and styrene) as described in ¶[0030]. The isoporous material comprises poly(isoprene-b-styrene-random-isoprene-b-4-vinylpyridine), 109 kg/mol, 19.1 wt % poly(isoprene), 56.8% poly(styrene), 24.1% poly(4-vinylpyridine), PDI=1.26. The polymer is dissolved at 15 wt % in 7:3 1,4-dioxane:acetone. The solution is dispensed, evaporates for 40 s, and is plunged into a water nonsolvent bath. An SEM image of the isoporous material is shown in FIG. 10.

### Example 6: A Separation Device Incorporating a Self-Assembled Isoporous Material Comprising at Least One BCP Comprising a Complex Architecture

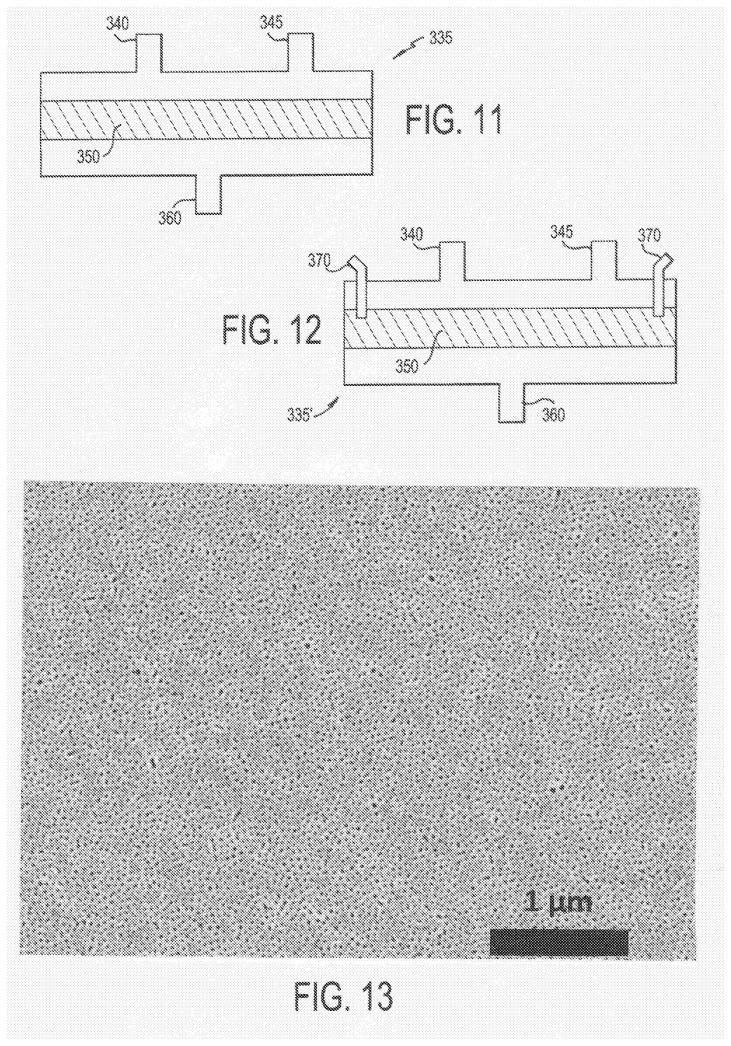

Any of the aforementioned isoporous materials can be incorporated into a separation device as depicted in FIG. 11. The separation device 335 includes at least one BCP comprising a complex architecture (350). The device includes an inlet (340) for the medium to be separated, and an outlet (360) for the separated media to exit. The FIG. 11 separation device could also include sensors 370, as in FIG. 12, such as electrodes to detect an analyte of interest to form a separation device 335′. A device may also optionally include a retentate port (345) for use as in a crossflow configuration.

As a person of ordinary skill in the art would understand, the FIG. 11 and FIG. 12 separation devices are examples of the types of separation devices that could incorporate any of the aforementioned complex architecture materials, and the examples therefore are not intended to be limiting. For example, other separation device structures can include the complex architecture materials having columnar, cylindrical, oval, rectangular, triangular, and other shapes for the intended application.

### Example 7: An Example of the Embodiment in ¶[0038]

The isoporous material comprises a BCP comprising a single unit of a distinct unit (—OH) covalently bonded to one chain terminus, as described in ¶[0038]. The isoporous material comprises poly(isoprene-b-styrene-b-4-vinylpyridine)-OH, 82 kg/mol, 28.6 wt % poly(isoprene), 50.3% poly(styrene), 21.1% poly(4-vinylpyridine), and a single unit of —OH at a terminus, PDI=1.14. The polymer is dissolved at 15 wt % in 7:3 1,4-dioxane:acetone. The solution is dispensed, evaporates for 100 s, and is plunged into a water nonsolvent bath. An SEM image of the isoporous material is shown in FIG. 13.

Table of features identified in FIGS. 1-12:

| | |
|---|---|
| 10 | Block architecture comprising branches of same |
| | composition as backbone |
| 20 | Block architecture comprising branches of different |
| | composition from backbone |
| 30 | Block architecture comprising multiple branches at branch |
| | sites comprising the same composition as backbone |
| 40 | Block architecture with multiple branches at branch sites |
| | comprising the same and different composition as |
| | backbone |
| 50 | Block architecture with multiple branches at branch sites |
| | with different composition from backbone |
| 60 | Block architecture with gradient composition/structure |
| | change across block |
| 70 | Block architecture containing a short oligomer of differing |
| | composition/structure |
| 80 | Block architecture containing two short, adjacent |
| | oligomers of differing composition/structure |
| 90 | Block architecture containing two short, nonadjacent |
| | oligomers of differing composition/structure |
| 100 | Triblock copolymer architecture comprising a ring |
| | architecture of one block |
| 110 | Triblock copolymer architecture comprising a ring |
| | architecture of all three blocks |
| 120 | Triblock copolymer architecture comprising a ring |
| | architecture of all three blocks and a branched architecture |
| | in one block comprising branches with a different |
| | composition from backbone |
| 130 | Hyperbranched star triblock copolymer architecture |
| | wherein each arm has multiple subsequent branches, |
| | dendritically. |
| 140 | Star triblock copolymer architecture wherein each arm |
| | comprises three distinct linear blocks, grown from a |
| | multifunctional initiator core. |
| 150 | Triblock copolymer architecture comprising a branched |
| | block wherein the branches are a different composition |
| | from the backbone. |
| 160 | Triblock copolymer architecture comprising a branched |
| | block wherein all the branches begin from the terminus of |
| | the middle block. |
| 170 | Tetra block copolymer architecture comprising two |
| | branched end blocks of the same composition wherein all |
| | the branches begin from the termini of the other two |
| | blocks. |
| 180 | Triblock copolymer architecture comprising a cross-linked |
| | block. |
| 200 | Diblock copolymer architecture comprising two distinct |
| | small oligomeric linkers adjacent to one another, between |
| | the two blocks. |
| 210 | Triblock copolymer architecture comprising two distinct |
| | small oligomeric linkers adjacent to one another, between |
| | two blocks. |
| 220 | Triblock copolymer architecture comprising a small |
| | oligomer at one end of the polymer structure. |
| 230 | Triblock copolymer architecture comprising two small |
| | oligomers of the same composition at either end of the |
| | polymer structure. |
| 240 | Triblock copolymer architecture comprising two small |
| | distinct oligomers at either end of the polymer structure. |
| 250 | Triblock copolymer architecture comprising two branched |
| | blocks wherein one block has all the branches begin from |
| | the terminus. of the middle block, and the adjacent block |
| | comprises branches of a different composition from the |
| | backbone |
| 260 | First polymer block, poly(isoprene) |
| 270 | Structure of eight-armed star poly(isoprene) polymer |
| | grown from multifunctional initiator |
| 280 | Structure of eight-armed star poly(isoprene)-block- |
| | poly(styrene) diblock copolymer grown from |
| | multifunctional initiator |
| 300 | Addition of second monomer (styrene) for second block |
| | polymerization |
| 305 | Second polymer block, poly(styrene) |
| 310 | Addition of third monomer (4-vinylpyridine) for second |
| | block polymerization |
| 320 | Third polymer block, poly(4-vinylpyridine) |
| 330 | Structure of eight-armed star poly(isoprene-b-styrene-b-4- |
| | vinylpyridine) triblock copolymer grown from |
| | multifunctional initiator |
| 335 | Separation device |
| 335′ | Separation device having sensors |
| 340 | Device inlet |
| 345 | Optional device retentate port |
| 350 | Isoporous material comprising at least one BCP |
| | comprising a complex architecture |
| 360 | Device outlet |
| 370 | Sensors such as electrodes to detect an analyte of interest |

What is claimed as new and desired to be protected by Letters Patent of the United States is:

1. A self-assembled polymer material containing at least one of macro, meso, or micro pores, at least some of which are isoporous, comprising a block copolymer or block copolymers (BCPs), with at least two chemically distinct blocks, which further comprises a complex architecture.

2. The material of claim 1 wherein at least a portion of the material is a block copolymer containing more than one monomer/chemistry/configuration/structure/composition in at least one block or adjacent to at least one block.

3. The material of claim 1 wherein at least a portion of the material is a diblock copolymer, triblock copolymer, or higher order (i.e. tetrablock, pentablock, etc.) with more than one monomer/chemistry/configuration/structure/composition in at least one block or adjacent to at least one block.

4. The material of claim 1, wherein the material has mesopores comprising a diameter of about 1 nm to about 200 nm.

5. The material of claim 1, wherein at least one block copolymer has an Mₙ of about 1×10³ to about 1×10⁷ g/mol.

6. The material of claim 1, wherein at least one block copolymer has a PDI of 1.0 to 3.0.

7. The material of of claim 1, wherein at least one block of the BCP has at least one of the following properties:
a. Low T_{g} (25° C. or less)
b. High T_{g} (more than 25° C.)
c. Hydrophilic
d. Hydrophobic
e. Chemically resistant
f. Chemically responsive
g. Chemically functional

8. The material of claim 1 wherein at least a portion of the material comprises at least one unit of one of the following polymer blocks or derivatives thereof:
a. Poly(butadiene)
b. Poly(isobutylene)
c. Poly(isoprene)
d. Poly(ethylene)
e. Poly(styrene)
f. Poly(methyl acrylate)
g. Poly(butyl methacrylate)
h. Poly(ethersulfone)
i. Poly(methyl methacrylate)
j. Poly(n-butyl acrylate)
k. Poly(2-hydroxyethyl methacrylate)
l. Poly(glycidyl methacrylate)
m. Poly(acrylic acid)
n. Poly(acrylamide)
o. Poly(sulfone)
p. Poly(vinylidene fluoride)
q. Poly(N,N-dimethylacrylamide)
r. Poly(2-vinylpyridine)
s. Poly(3-vinylpyridine)
t. Poly(4-vinylpyridine)
u. Poly(ethylene glycol)
v. Poly(propylene glycol)
w. Poly(vinyl chloride)
x. Poly(tetrafluoroethylene)
y. Poly(ethylene oxide)
z. Poly(propylene oxide)
aa. Poly(N-isopropylacrylamide)
bb. Poly(dimethylaminoethyl methacrylate)
cc. Poly(amic acid)
dd. Poly(dimethylsiloxane)
ee. Poly(lactic acid)
ff. Poly(isocyanate)
gg. Poly(ethyl cyanoacrylate)
hh. Poly(acrylonitrile)
ii. Poly(hydroxystyrene)
jj. Poly(methylstyrene)
kk. Poly(ethyleneimine)
ll. Poly(styrene sulfonate)
mm. Poly(allylamine hydrochloride)
nn. Poly(pentafluorostyrene)
oo. Poly(2-(perfluorohexyl)ethyl methacrylate)
pp. Poly(methacrylic acid)
qq. Poly(ethylene sulfide)
rr. Poly(propylene sulfide)

9. A method of preparing the material of claim 1, comprising:
a. Dissolution of polymer in at least one chemical solvent
b. Dispensing polymer solution onto a substrate or mold, or through a die or template
c. Removal of at least a portion of chemical solvent
d. Exposure to a nonsolvent causing precipitation of at least a portion of the polymer
e. Optionally, a wash step

10. The method of claim 9 wherein at least a portion of the chemical solvent is from one of the following classes:
a. Alcohol,
b. Aldehyde,
c. Alkane,
d. Amide,
e. Amine,
f. Cyclic aromatic,
g. Carboxylic acid,
h. Ester,
i. Ether,
j. Ketone,
k. Lactam,
l. Nitrile,
m. Organohalide,
n. Polyol,
o. Sulfone, or
p. Sulfoxide

11. The method of claim 9 wherein at least a portion of the chemical solvent contains at least one of the following or its derivatives:
a. Acetone,
b. Acetaldehyde,
c. Methanol,
d. Ethanol,
e. Ethyl acetate,
f. Dimethoxyethane,
g. Hexane,
h. Chloroform,
i. Dichloromethane,
j. Acetonitrile,
k. Tetrahydrofuran,
l. Cyclohexane,
m. Benzene,
n. Toluene,
o. Dimethyl sulfoxide,
p. Dimethylformamide,
q. Dimethylacetamide,
r. N-Methyl-2-pyrrolidone,
s. Pyridine,
t. 1,4-Dioxane,
u. Acetic acid,
v. Formic acid, or
w. Propanol
x. Sulfolane

12. The method of claim 9 wherein the BCP solution further comprises at least one additional macromolecule or a small molecule.

13. A process separating or detecting an analyte of interest by contacting a medium containing the analyte of interest with at least one material of claim 1.

14. A process using at least one material of claim 1 for separation or filtration of liquids or gases.

15. A process using at least one material of claim 1 for the filtration, separation, or removal of one or more viruses from a liquid or gas.

16. The material of claim 1 wherein the material comprises more than one BCP.

17. The material of claim 1 wherein at least a portion of at least one BCP comprises more than one distinct monomer type in at least one block, between blocks, or at the end of at least one block.

18. The material of claim 1 wherein at least a portion of at least one BCP is branched.

19. The material of claim 1 wherein at least a portion of at least one BCP is crosslinked.

20. The material of claim 1 wherein at least a portion of at least one BCP is a ring architecture.
